(19) United States
(12) Patent Application Publication
(10) Pub. No.: US 2014/0369055 A1
(43) Pub. Date: Dec. 18, 2014

(54) LED LIGHTING APPARATUS AND HEAT SINK THEREOF

(71) Applicant: Spinlux Technology Co., New Taipei City (TW)

(72) Inventors: Shih-En TSOU, New Taipei City (TW); Shyh-Shiun SHEU, New Taipei City (TW)

(73) Assignee: SPINLUX TECHNOLOGY CO., New Taipei City (TW)

(21) Appl. No.: 14/073,899

(22) Filed: Nov. 7, 2013

(30) Foreign Application Priority Data
Jun. 18, 2013 (TW) 102121636

(51) Int. Cl. F21V 29/00; F28F 3/02

(52) U.S. Cl. CPC F21V 29/2206; F28F 3/02
USPC 362/373; 165/185

(57) ABSTRACT

In an LED lighting apparatus and a heat sink thereof, the heat sink includes a heat dissipation structure for airflows, and the heat dissipation structure includes: a plurality of heat conductive rods arranged spaced apart from each other in rows and attached at a back side of an LED light engine; each heat conductive rod including an extension portion horizontally extended on at least one side of the LED light engine and a plurality of surfaces; and a plurality of fin modules attached to two corresponding surfaces of each one of the extension portions respectively; each fin module including a plurality of fins spaced apart from each other; wherein an air gap is formed between any two of the adjacent fin modules and a fin channel is formed between any two of the adjacent fins such that air flows through these air gaps and fin channels.

### BACKGROUND OF THE INVENTION

1. Field of the Invention

The present invention is related to a heat sink, in particular, to an LED lighting apparatus and a heat sink thereof.

2. Description of Related Art

During the operation of LED, approximately 80% of the total energy is transmitted to the environment in the form of waste heat. However, the operation in high temperature can have significant effects on electronic components, such as lifetime, product reliability and light decay.

A known LED light engine comprises a circuit board and a plurality of LED units electrically connected on the circuit board. With the heat sink provided on the LED light engine, the heat generated by the LED units can be dissipated via the heat sink such that the lifetime of the LED units can be extended, the reliability of the LED units can be increased and the light decay of the LED units can be reduced.

However, most of the known heat sinks typically are aluminum extrusion or aluminum die-casting type of heat sinks, or the back side of the LED light engine is provided with a plurality of fin modules connected with heat pipes. Such designs are insufficient in that they overlook the importance of airflows but focus mainly on the surface areas of the fins, which tends to lead to the problem of poor heat dissipation of the LED light engine without improvements.

Furthermore, the aluminum extrusion or fin type of heat sinks can only allow the air to enter at the direction parallel to the fins. When the heat sink is overly large, such as the surface area of the heat sink is too large or too long, the air cannot reach the center of the heat sink (i.e. the location of the heat generating unit) at all, which causes the effect of heat dissipation to be greatly reduced. To solve such problem, it is a common practice to introduce a cutting slot in the direction perpendicular to the aluminum extruded fins; however, the problem is still not being overcome completely due to the limited effects of insufficient width of the cutting slot. On the other hand, if the width of the cutting slot is too large, a large portion of the surface area of the fins for heat dissipation would be wasted, which is not only difficult in practice but also results in limited effects of heat dissipation.

In addition, the aforementioned heat sinks are only suitable for low-power LED lighting apparatus and heat sinks For high-power LED light engines (such as 1000˜5000 W) of the present time, they are clearly insufficient; in view of above, there is a need for an improved heat sink applicable to high-power LED light engines and capable of achieving heat dissipation effectively.

### SUMMARY OF THE INVENTION

A first aspect of the present invention is to provide an LED lighting apparatus and a heat sink thereof, which is able to use the lateral wings not only to extend outward from the LED light engine but also to allow the air to flow upward and downward for heat dissipation in order to improve the problem of heat dissipation of LED light engines.

A second aspect of the present invention is to provide an LED lighting apparatus and a heat sink thereof, which is able to form air channels via a special connection method and between any two adjacent fin modules in order to form longitudinal and latitudinal intersections and cross links among air channels and fin channels, in a manner similar to the chessboard, such that the heat dissipation areas are increased while allowing the air to flow freely to any parts of the heat sink to enhance the effect of the heat dissipation.

A third aspect of the present invention is to provide an LED lighting apparatus and a heat sink thereof, which is capable of allowing the heat sinks to be vertically stacked on top of each other layer by layer with an increasing height in order to increase the heat dissipation capacity and to meet the demands of current LED light engine of increasingly higher powers.

Accordingly, the present invention provides a heat sink comprising a heat dissipation structure for airflows, and the heat dissipation structure comprises: a plurality of heat conductive rods arranged spaced apart from each other in rows; each one of the plurality of heat conductive rods comprising an extension portion; each one of the plurality of heat conductive rods further comprising a plurality of surfaces; and a plurality of fin modules attached to two corresponding surfaces of the plurality of surfaces of each one of the extension portions respectively; and each one of the fin modules comprising a plurality of fins spaced apart from each other; wherein an air gap is formed between any two of the plurality of fin modules adjacent to each other and a fin channel is formed between any two of the plurality of fins adjacent to each other such that air flows longitudinally through the plurality of air gaps and the plurality of fin channels.

The present invention further provides an LED lighting apparatus comprising: an LED light engine; and a heat sink comprising a heat dissipation structure for airflows. The heat dissipation structure comprises: a plurality of heat conductive rods arranged spaced apart from each other in rows and attached at a back side of the LED light engine; each one of the plurality of heat conductive rods comprising an extension portion extended horizontally on at least one side of the LED light engine; each one of the plurality of heat conductive rods further comprising a plurality of surfaces; and a plurality of fin modules attached to two corresponding surfaces of the plurality of surfaces of each one of the extension portions respectively; and each one of the fin modules comprising a plurality of fins spaced apart from each other; wherein an air gap is formed between any two of the plurality of fin modules adjacent to each other and a fin channel is formed between any two of the plurality of fins adjacent to each other such that air flows longitudinally through the plurality of air gaps and the plurality of fin channels.

In comparison to the related arts, the present invention is of the following merits: regardless whether the heat dissipation structure is a single layer or double layer structure, it can be used for lateral wing type of heat dissipation allowing the air to flow vertically therein in order to overcome the heat dissipation problem of LED light engines.

### BRIEF DESCRIPTION OF DRAWING

FIG. 1 is an exploded view of the first embodiment of the LED lighting apparatus of the present invention;

FIG. 2 is an exploded view of the second embodiment of the LED lighting apparatus of the present invention;

FIG. 3 is a perspective view of the assembly of the present invention in FIG. 2;

FIG. 4 is side view of the present invention in FIG. 3;

FIG. 5 is a top view of the second embodiment of the LED lighting apparatus of the present invention;

FIG. 6 is a front view of the first and second embodiments of the LED lighting apparatus of the present invention;

FIG. 7 is a front view of the third embodiment of the LED lighting apparatus of the present invention;

FIG. 8 is a perspective view of the fourth embodiment of the LED lighting apparatus of the present invention;

FIG. 9 is a front view of the fifth embodiment of the LED lighting apparatus of the present invention; and

FIG. 10 is a side view showing the adjustment of the illumination angle of the LED lighting apparatus of the present invention.

### DETAILED DESCRIPTION OF THE INVENTION

The following provides detailed description of embodiments of the present invention along with the accompanied drawings. It can, however, be understood that the accompanied drawings are provided for illustrative purposes only and shall not be treated as limitations to the present invention.

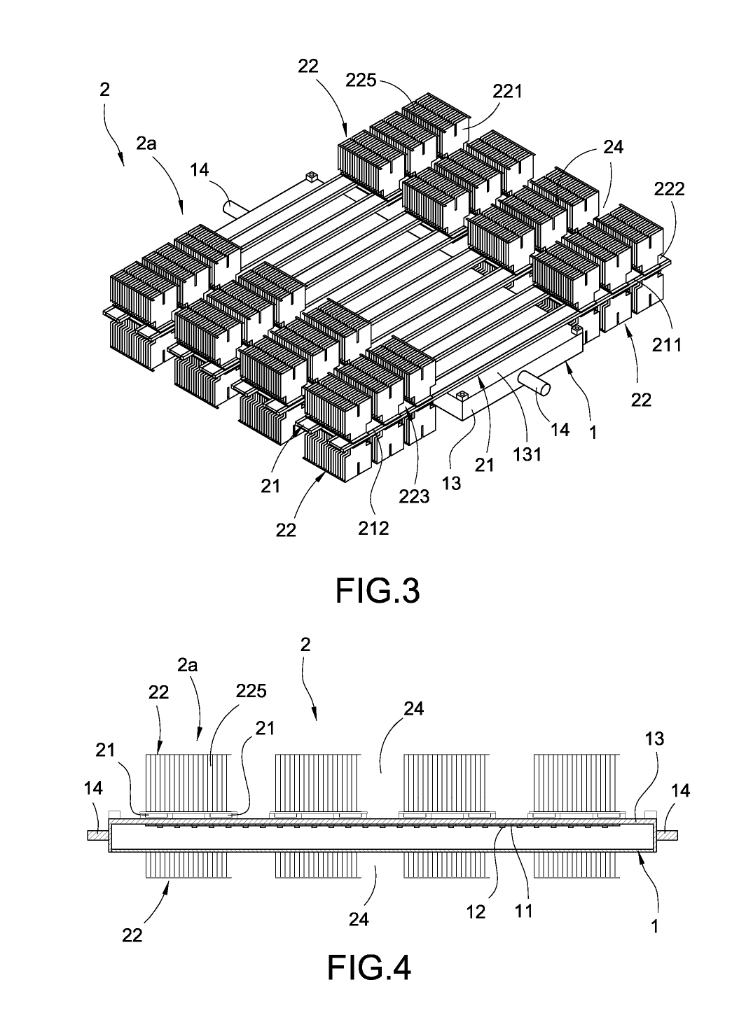

The preset invention provides an LED lighting apparatus and a heat sink thereof. As shown in FIG. 4, the LED lighting apparatus comprises an LED light engine 1 and a heat sink 2. The LED light engine 1 can either comprise only a circuit board 11 having a plurality of LED units 12 connected thereon or further comprise a light housing 13 with the circuit board 11 arranged inside the light housing 13. That is, the circuit board 11 is flatly attached to a front side of the light housing 13 as shown in the figure. The light emitting side of the light housing 13 can be further covered with a light shell shown without reference numeral. The LED light engine 1 further comprises a rotating axle 14 (see FIG. 3).

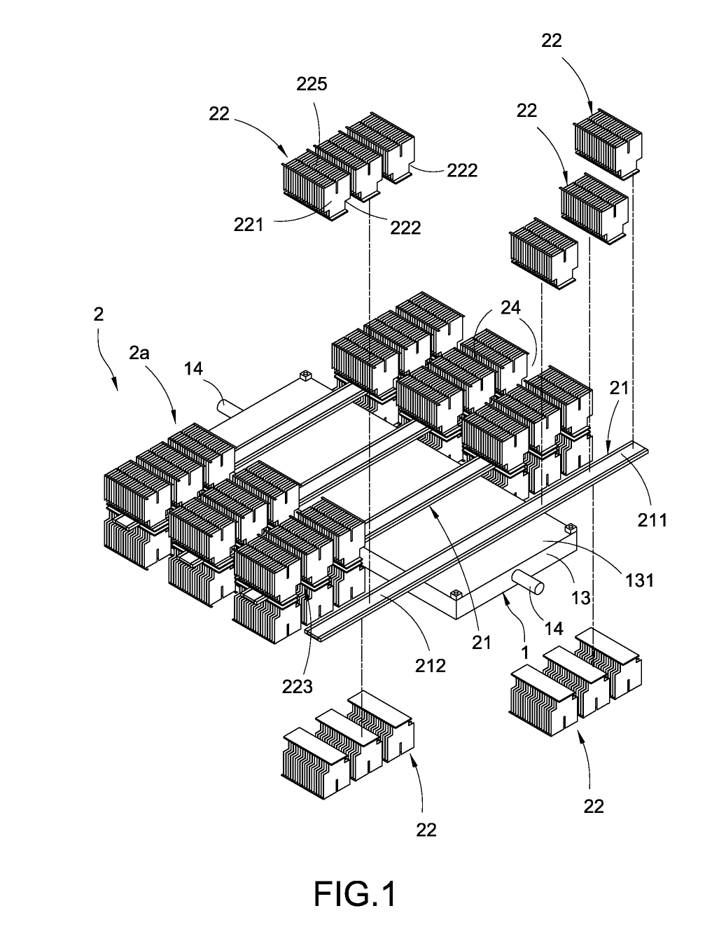

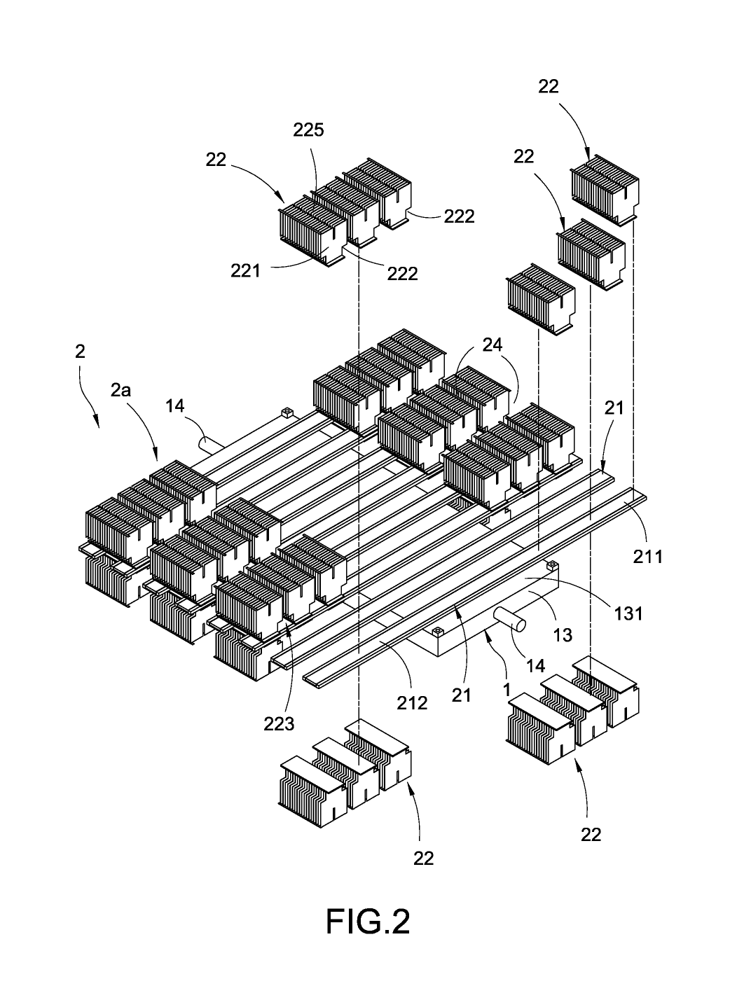

FIG. 1 shows a first embodiment (please also see FIGS. 2-6) of the present invention. The heat sink 2 of the present invention comprises a heat dissipation structure 2a for airflows to achieve heat dissipation. The heat dissipation structure 2a comprises a plurality of heat conductive rods 21 and a plurality of fin modules 22.

Each one of the heat conductive rods 21 comprises a plurality of surfaces (they can be flat heat conductive rods as shown in the figure) which include an upper surface and a lower surface. These heat conductive rods 21 are arranged spaced apart from each other in rows and attached to a back side 131 of the LED light engine 1. Each one of the heat conductive rods 21 comprises an extension portion 211 extended horizontally on at least one side of the LED light engine 1. In this embodiment, the heat conductive rod 21 further comprises another extension portion 212 extended horizontally on another side of the LED light engine 1, and the extension portion 211 and the another extension portion 212 are located at two opposite ends.

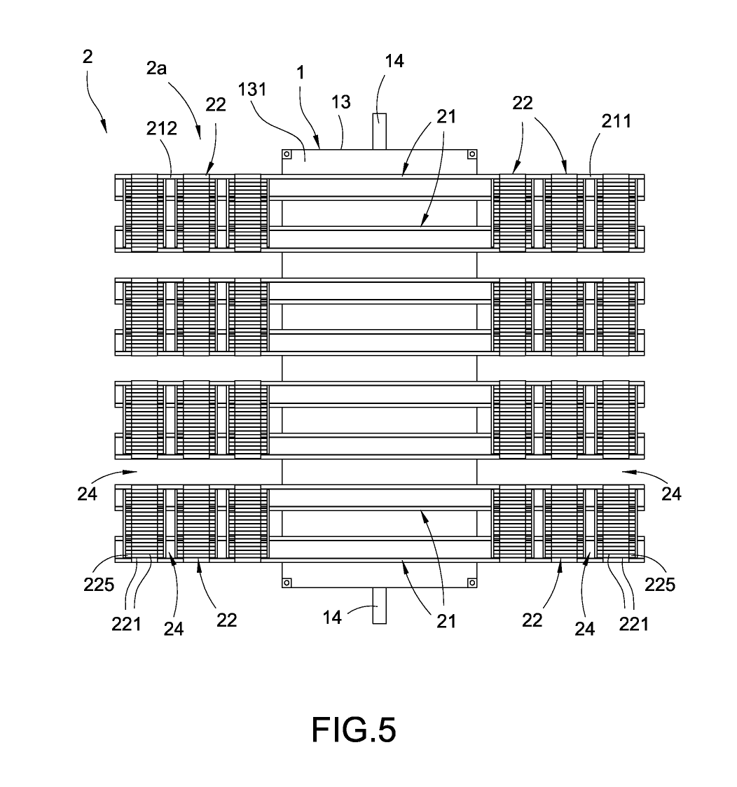

Each one of the fin modules 22 comprises a plurality of fins 221 spaced apart from each other (see FIGS. 3 and 5). An air gap 24 is formed between any two of the fin modules 22 adjacent to each other and a fin channel 225 is formed between any two of the fins 221 adjacent to each other such that air flows through these air gaps 24 and these fin channels 225.

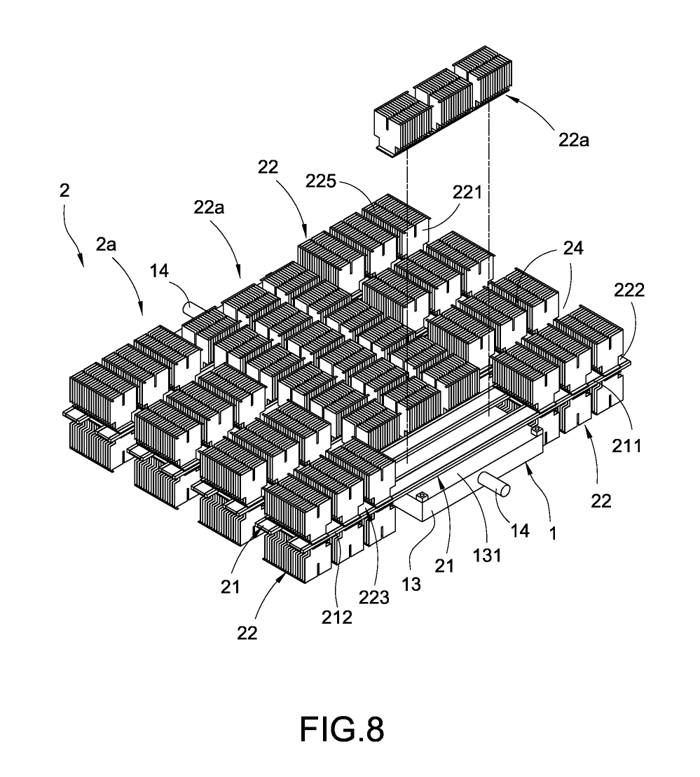

As shown in FIG. 1, these fin modules 22 are attached to the upper surface and lower surface of each one of the extension portions 211 and to the upper surface and lower surface of each one of the another extension portions 212. Certainly, the fin modules 22 can also only attach to the upper surface or lower surface of the extension portion and the another extension portion 212 as long as they are sufficient for heat dissipation. In other words, the first embodiment uses one fin module 22 attached to one heat conductive rod 21. As for the second embodiment shown in FIGS. 2-6 or for the third, fourth and fifth embodiments shown in FIGS. 7-9, although one fin module 22 connected to two adjacent heat conductive rods 21 (as shown in FIGS. 2-10), the present invention is not limited to such configuration and the second to fifth embodiments can all use one fin module 22 to attach to one heat conductive rod 21. In the following description for the second to fifth embodiments, the connection method having one fin module 22 attached to one heat conductive rod 21 (as shown in FIG. 1) is used for illustration in a concise manner.

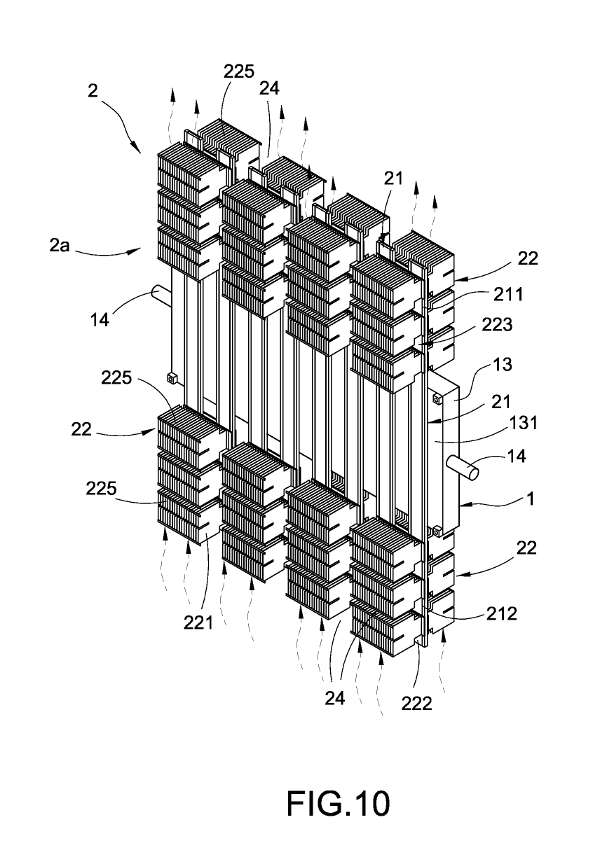

With the design of the first and second embodiments, the air is able to flow longitudinally through the two lateral wings opposite to each other on the LED light engine 1. In other words, since the extension portions 211 and the another extension portions 212 extended on the two opposite sides of the LED light engine 1 with a plurality of fin modules 22 attached thereto would not be blocked by the LED light engine 1, the air can be ensured to flow longitudinally to facilitate the heat dissipation (due to the rise of hot air and the sink of cool air) and to enhance the effect of heat dissipation. Furthermore, the rotating axle 14 is not necessary to be oriented perpendicular to the heat conductive rod 21 as shown in FIG. 5, it can also be at an angle other than 90 degrees with the heat conductive rod 21 as long as the air flowing longitudinally is maintained to flow smoothly either prior to or after the adjustment of the illumination angles thereof. For example, the direction of the fins 221, as shown in FIG. 5, are perpendicular to the rotating axle 14 (or parallel to the heat conductive rod 21); therefore, as shown in FIG. 10, when the LED lighting apparatus is being adjusted for an illumination angle with the rotating axle 14, the entire surface of the fins 221 can still be parallel to the longitudinal direction of airflow such that the longitudinally flowing air is able to flow through the fin channels 225 without being blocked by the fins 221 to facilitate the heat dissipation thereof.

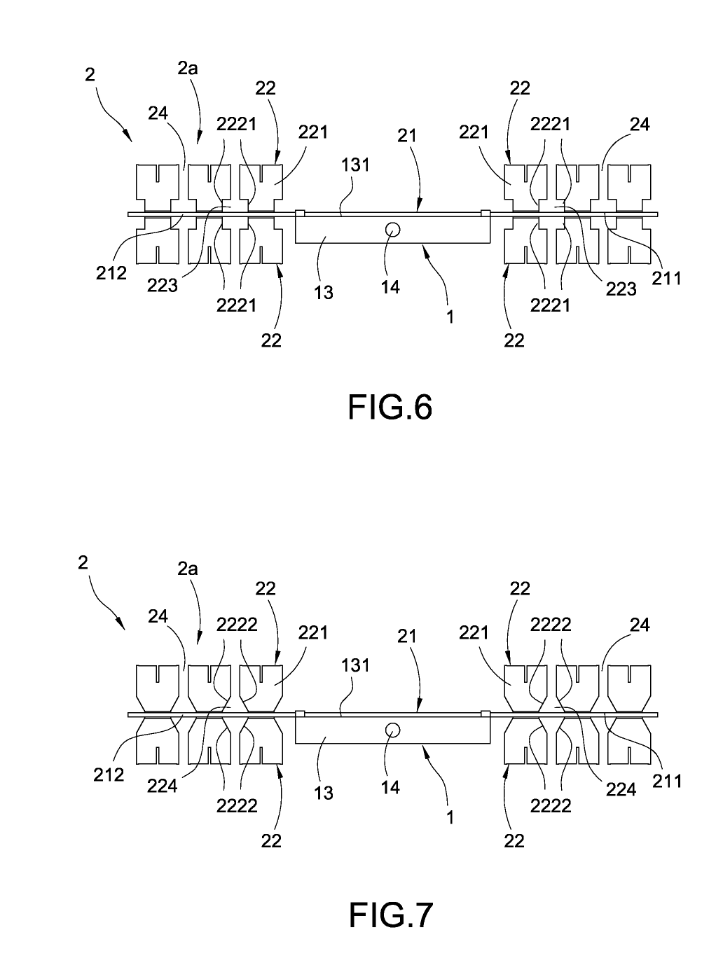

One side of the fins 221 can be provided with a groove 222. In the first and second embodiments, the two grooves 222 are formed at the lower-left corner and the lower-right corner of the two opposite sides of one fin 221 respectively. The grooves 222 can be any shapes of cut-out portions. For example, as shown in FIG. 6 (the first and second embodiments) along with FIGS. 1-5, 8 and 9, the groove 222 can be a rectangular cut-out portion 2221. A rectangular cut-out portion 2221 is formed at the lower-left corner of the one side of each fin 221, and simultaneously another rectangular cut-out portion 2221 is formed at the lower-right corner of the other side of the fin 221, therefore four rectangular cut-out portions 2221 (see FIG. 6) form a rectangular opening, and the plurality of openings can be connected to each other in series to form a rectangular air channel 223. As shown in FIG. 7 (the third embodiment), the groove 222 can also be a slanted cut-out portion 2222. A slanted cut-out portion 2222 is formed at the lower-left corner of the one side of each fin 221, and simultaneously another slanted cut-out portion 2222 is formed at the lower-right corner of the other side of the fin 221, therefore four slanted cut-out portions 2222 form a rhombus or parallelogram opening, and the plurality of openings can be connected to each other in series to form a rhombus or parallelogram air channel 224. In an actual operation, the air channels 223, 224 can be formed by either any two of the rectangular cut-out portions 2221 or any two of the slanted cut-out portions 2222.

In detail, each one of the fin modules 22 can be connected to the upper surface or lower surface of the heat conductive rods with the bottoms of all of the fins 221 in order to allow either the rectangular air channels 223 or the rhombus or parallelogram air channels 224 to be formed with each one of the grooves 222 between any four of the fin modules adjacent to each other. Certainly, each one of the extension portion 221s or each one of the another extension portions 212 can be attached to the plurality of fin modules 22, and the fin modules 22 of each one of the heat conductive rods 21 are arranged in a straight line such that the air channels 223 or 224 are fluidly connected in series, as shown in the figures, and such that the upper surfaces or the lower surfaces of the extension portions 211 (or another extension portions 212) are connected with two fin modules 22 parallel to each other. As shown in FIGS. 1 and 2 along with FIG. 5, the length of the fin modules 22 is greater than the width of the extension portions 211, 212 such that the fin modules 22 also include a protruded portion (shown without reference numeral) protruding outward from the heat conducive rods 21 to allow the longitudinally flowing air to flow through and to contact such protruded portion in order to facilitate the air to carry away the heat on the protruded portion of the fins 221 for heat dissipation.

The heat conductive rods 21 can be directly connected to the back side (not shown in the figure) of the circuit board 11 of the LED light engine 1, and the extension portions 221 and the another extension portions 212 extend horizontally on two opposite sides of the circuit board 11. Certainly, they can also be connected to the back side 131 (as shown in FIGS. 4 and 6) of the light housing 13 of the LED light engine 1, and the extension portions 211 and the another extension portions 212 extend horizontally on two opposite sides of the light housing 13. Such two ways can all transfer the heat from the LED units 12 to the fin modules 22 via the heat conductive rods 21.

Furthermore, as shown in FIGS. 4 and 6, when the heat is transferred from the circuit board 11 to the heat conductive light housing 13, the heat is dissipated while being transferred to the plurality of heat conductive rods 21 and further to the fin modules 22. Since the fin modules 22 are attached to the upper and lower surfaces of the heat conductive rods 21 and since there is great number of fins 211, the heat dissipation area is increased. In addition, as there are plurality of air channels 223 (or 224) intersecting and linking with plurality of fin channels 225, the air is able to flow freely among the longitudinally and laterally intersecting air channels 223 (or 224) and fin channels 225, in a manner similar to the chessboard, without any obstacles; in other words, the air is able to flow freely through the heat sink 2. Therefore, the heat dissipation area and the effect of heat dissipation of the first, second and third embodiments of the present invention can be enhanced greatly such that they are applicable to LED light engine 1 of such as 1000 W of working power.

FIG. 8 shows a fourth embodiment of the present invention, which is generally similar to the second embodiment and with the addition of a plurality of heat dissipators. The heat dissipators can be any heat dissipation structure (not shown in figure), which can certainly be the another fin module 22a of the aforementioned fin module 22. All of the fin modules 22a are attached to the back side 131 of the LED light engine 1 to enhance the effect of heat dissipation.

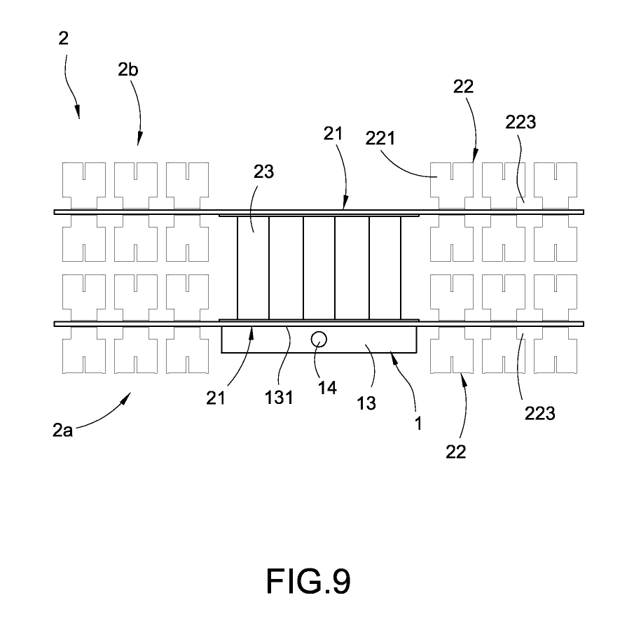

FIG. 9 shows a fifth embodiment of the present invention, which is similar to the second embodiment and with the addition of a second layer as well as being connected with column-shaped heat conductive rods 23. As shown in the figure, the aforementioned heat sink 2 comprises the aforementioned heat dissipation structure 2a at a lower portion, the another heat dissipation structure 2b at an upper portion and a plurality of column-shaped heat conductive rods 23 connected between the heat dissipation structure 2a and the another heat dissipation structure 2b. The column-shaped heat conductive rods 23 are vertically connected between the heat dissipation structure 2a and the another heat dissipation structure 2b. In addition, one end of the column-shaped heat conductive rods 23 is connected to an upper surface of the heat conductive rods 21 of the heat dissipation structure 2a (and at an upper surface between the extension portion 211 and the another extension portion 212). Another end column shaped of heat conductive rods 23 is connected to a lower surface of the heat conductive rods 21 of the another heat dissipation structure 2b (and at a lower surface between the extension portion 211 and the another extension portion 212).

Accordingly, it is of greater heat dissipation area and significantly enhanced effect of heat dissipation such that it is applicable to LED light engine 1 of higher working power (such as 2000˜5000 W or even greater than 5000 W). Furthermore, the heat sinks 2 can be stacked on top of another layer by layer with an increasing height (such as a heat dissipation structure of a height of three layers but not shown in the figure), and the present invention is not limited to any number of layers.

In view of the above, the present invention includes the following advantages over the related arts: with the extensions from the LED light engine 1, the longitudinally airflow is able to achieve the lateral wing type of heat dissipation to enhance the effect of heat dissipation and to overcome the problem of heat dissipation of LED light engines. In addition, with the special connection methods of the heat conductive rods 21, fin modules 22 and the fins 221 thereof, the heat dissipation area is significantly increased. Furthermore, the intersecting and linking configuration among the air channels 223 (or 224) and the fin channels 225, in a manner similar to the chessboard, allows the air to flow freely to any parts of the heat sink 2 to greatly enhance the effect of heat dissipation and such that the known problem of insufficient heat dissipation area and the shortcoming of the air unable to reach particular spots (such as the center of the heat sink) can be overcome.

Furthermore, the present invention is of the further merits: by allowing the heat sink to be stacked on top of another layer by layer with an increasing height, the heat dissipation capacity thereof can be further increased.

The above provides preferred embodiments of the present invention for illustrative purposes only and shall not be treated as limitations to the scope of the present invention. Any structural modifications of equivalent effects based on the content and drawings of the specification of the present invention shall be deemed to be within the scope of the present invention.

What is claimed is:

1. A heat sink comprising a heat dissipation structure for airflows, the heat dissipation structure comprising:
a plurality of heat conductive rods, arranged spaced apart from each other in rows; each one of the plurality of heat conductive rods comprising an extension portion; each one of the plurality of heat conductive rod further comprising a plurality of surfaces; and
a plurality of fin modules, connected to two corresponding surfaces of the plurality of surfaces of each one of said extension portions respectively; and each one of the fin modules comprising a plurality of fins spaced apart from each other; wherein an air gap is formed between any two of the plurality of fin modules adjacent to each other and a fin channel is formed between any two of the plurality of fins adjacent to each other such that air flows longitudinally through the plurality of air gaps and the plurality of fin channels.

2. The heat sink according to claim 1, wherein each one of the plurality heat conductive rods further comprises another extension portion; the extension portion and the another extension portion are located at two opposite ends of each one of the plurality of heat conductive rods; another plurality of fin modules are also respectively connected to two corresponding surfaces of the plurality of surfaces of each one of the another extension portions.

3. The heat sink according to claim 2, further comprising another heat dissipation structure and a plurality of column-shaped heat conducive rods; the plurality of column-shaped heat conductive rods are perpendicularly connected between the heat dissipation structure and the another heat dissipation structure; the two corresponding surfaces of each one of the plurality of heat conductive rods are an upper surface and a lower surface; one end of the plurality of column-shaped heat conductive rod is connected between the extension portion and the another extension portion of the heat dissipation structure and at the lower surface of each one of the plurality of heat conductive rods; another end of the plurality of column-shaped heat conductive rod is connected between the extension portion and the another extension portion of the heat dissipation structure and at the upper surface of each one of the plurality of heat conductive rods.

4. The heat sink according to claim 1, wherein at least one side of each one of the plurality of fins is provided with a groove; and an air channel is formed by the each one of the grooves and between any two of the plurality of fin modules adjacent to each other.

5. The heat sink according to claim 4, wherein another side of each one of the plurality of fins is also provided with another groove; the one side and the another side of each one of the plurality of fins are faced to each other; and another air channel is formed by the each one of the another grooves and between any four of the plurality of fin modules adjacent to each other.

6. The heat sink according to claim 4, wherein the groove of each one of the plurality of fins is a cut-out portion; the cut-out portion is formed between a side and a bottom of each one of the plurality of fins; each one of the plurality of fin modules is connected to one of the two corresponding surfaces of the heat conductive rod with the bottom of each one of the plurality of fins.

7. An LED lighting apparatus, comprising:
an LED light engine; and
a heat sink comprising a heat dissipation structure for airflows; the heat dissipation structure comprising:
a plurality of heat conductive rods, arranged spaced apart from each other in rows and connected at a rear side of the LED light engine; each one of the plurality of heat conductive rods comprising an extension portion extended horizontally on at least one side of the LED light engine; each one of the plurality of heat conductive rod further comprising a plurality of surfaces; and
a plurality of fin modules, connected to two corresponding surfaces of the plurality of surfaces of each one of the extension portions respectively; and each one of the fin modules comprising a plurality of fins spaced apart from each other; wherein an air gap is formed between any two of the plurality of fin modules adjacent to each other and a fin channel is formed between any two of the plurality of fins adjacent to each other such that air flows longitudinally through the plurality of air gaps and the plurality of fin channels.

8. The LED lighting apparatus according to claim 7, wherein each one of the plurality heat conductive rods comprises the extension portion extended horizontally on one side of the LED light engine; each one of the plurality heat conductive rods further comprises another extension portion extended horizontally on another side of the LED light engine; the extension portion and the another extension portion are located at two opposite side of each one of the plurality of heat conductive rods; another plurality of fin modules are also respectively connected to two corresponding surfaces of the plurality of surfaces of each one of the another extension portions.

9. The LED lighting apparatus according to claim 8, wherein the heat sink further comprises another heat dissipation structure and a plurality of column-shaped heat conducive rods; the plurality of column-shaped heat conductive rods are perpendicularly connected between the heat dissipation structure and the another heat dissipation structure; the two opposite surfaces of each one of the plurality of heat conductive rods are an upper surface and a lower surface; one end of the plurality of column-shaped heat conductive rod is connected between the extension portion and the another extension portion of the heat dissipation structure and at the lower surface of each one of the plurality of heat conductive rods; another end of the plurality of column-shaped heat conductive rod is connected between the extension portion and the another extension portion of the heat dissipation structure and at the upper surface of each one of the plurality of heat conductive rods.

10. The LED lighting apparatus according to claim 7, wherein at least one side of each one of the plurality of fins is provided with a groove; and an air channel is formed by the each one of the grooves and between any two of the plurality of fin modules adjacent to each other.

11. The LED lighting apparatus according to claim 10, wherein another side of each one of the plurality of fins is also provided with another groove; the one side and the another side of each one of the plurality of fins face with each other; and another air channel is formed by the each one of the another grooves and between any four of the plurality of fin modules adjacent to each other.

12. The LED lighting apparatus according to claim 10, wherein the groove of each one of the plurality of fins is a cut-out portion; the cut-out portion is formed between a side and a bottom of each one of the plurality of fins; each one of the plurality of fin modules is connected to one of the two corresponding surfaces of the heat conductive rod with the bottom of each one of the plurality of fins.

13. The LED lighting apparatus according to claim 7, wherein the LED light engine further comprises a circuit board; a plurality of LED units are electrically connected on the circuit board; each one of the plurality of heat conductive rods is directly attached to a back side of the circuit board; and the extension portion extends horizontally on at least one side of the circuit board.

14. The LED lighting apparatus according to claim 7, wherein the LED light engine further comprises a light housing and a circuit board having a plurality of LED units electrically connected thereto; the circuit board is flatly attached to a front side of the light housing; each one of the plurality of heat conductive rods is attached to a back side of the light housing; and the extension portion extends horizontally on at least one side of the light housing.

15. The LED lighting apparatus according to claim 7, wherein the heat sink further comprises a plurality of heat dissipators; each one of the heat dissipators is attached to the back side of the LED light engine.
